(19) United States
(12) Patent Application Publication
(10) Pub. No.: US 2019/0319665 A1
(43) Pub. Date: Oct. 17, 2019

(54) METHOD FOR MITIGATING INTERFERENCE AND INTERFERENCE MITIGATING RECEIVER

(71) Applicant: Intel IP Corporation, Santa Clara, CA (US)

(72) Inventors: Markus Jordan, Gelsenkirchen (DE); Herbert Dawid, Herzogenrath (DE); Umer Salim, Antibes (FR); Edgar Bolinth, Korschenbroich (DE); Thomas Esch, Kaarst (DE)

(21) Appl. No.: 15/738,468

(22) PCT Filed: May 23, 2016
(86) PCT No.: PCT/EP2016/061593

§ 371 Date: Mar. 20, 2018

(30) Foreign Application Priority Data
Jun. 25, 2015 (DE) 10 2015 110 211.0

(51) Int. Cl. H04B 1/7105; H04B 7/08; H04B 1/711; H04B 17/354

(52) U.S. Cl. CPC H04B 1/71055; H04B 17/354; H04B 1/711; H04B 7/0854

(57) ABSTRACT

A method (200) for mitigating interference includes: receiving (201) a first signal (y₁) comprising a first plurality of multipath transmissions from at least one radio cell at a first antenna port (A) and a second signal (y₂) comprising a second plurality of multipath transmissions from the at least one radio cell at a second antenna port (B); generating (202) a first spatial component (h_{1A}) of a first channel coefficient (h₁) based on the first signal (y₁) and a second spatial component (h_{1B}) of the first channel coefficient (h₁) based on the second signal (y₂); generating (203) a covariance measure (R_{y}) based on the first signal (y₁) and the second signal (y₂); and generating (204) a first spatial component (w_{1A}) of a first weight (w₁) for interference mitigation based on the covariance measure (R_{y}), the first and second spatial components (h_{1A}, h_{1B}) of the first channel coefficient (h₁) and a scalar correction value (C).

### FIELD

The disclosure relates to a method for mitigating interference and an interference mitigating receiver. In particular, the disclosure relates to a semiparametric Wiener Interference Cancellation (WIC) technique for interference mitigation that may be applied on a chip-rate basis.

### BACKGROUND

In a radio frequency communications system 100, e.g. as illustrated in FIG. 1 transmission may occur via multiple transmission channels 102, 103, 104, 105, e.g. when using a transmission system including multiple transmit and/or receive antennas 121, 122 or when receiving signals from multiple radio cells 110, 160. Signals propagating from the transmitter(s) to the receiver via different transmission channels 102, 103, 104, 105 may be deteriorated or lost due to multipath fading or shadowing. Interference and noise may occur during signal transmission, propagation over the different transmission channels 102, 103, 104, 105 and signal reception at the receiver 120. There is a need to improve interference mitigation at the receiver 120.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description.

FIG. 1 is a schematic diagram illustrating an exemplary radio frequency communications system 100 including a serving radio cell 110, an interfering radio cell 160 and a mobile receiver 120.

FIG. 2 schematically illustrates a method 200 for mitigating interference in accordance with the disclosure.

FIG. 3 schematically illustrates an interference mitigating receiver circuit 300 in accordance with the disclosure.

FIG. 4 schematically illustrates an interference mitigating receiver 400 in accordance with the disclosure.

FIG. 5a illustrates an exemplary performance diagram 500a illustrating block error rates for a VA120 channel when using different interference mitigation techniques.

FIG. 5b illustrates an exemplary performance diagram 500b illustrating block error rates for a Case3 channel when using different interference mitigation techniques.

### DETAILED DESCRIPTION

In the following, embodiments are described with reference to the drawings, wherein like reference numerals are generally utilized to refer to like elements throughout. In the following description, for purposes of explanation, numerous specific details are set forth in order to provide a thorough understanding of one or more aspects of embodiments. However, it may be evident to a person skilled in the art that one or more aspects of the embodiments may be practiced with a lesser degree of these specific details. The following description is therefore not to be taken in a limiting sense.

The various aspects summarized may be embodied in various forms. The following description shows by way of illustration various combinations and configurations in which the aspects may be practiced. It is understood that the described aspects and/or embodiments are merely examples, and that other aspects and/or embodiments may be utilized and structural and functional modifications may be made without departing from the scope of the present disclosure.

In addition, while a particular feature or aspect of an embodiment may be disclosed with respect to only one of several implementations, such feature or aspect may be combined with one or more other features or aspects of the other implementations as may be desired and advantageous for any given or particular application. Further, to the extent that the terms “include”, “have”, “with” or other variants thereof are used in either the detailed description or the claims, such terms are intended to be inclusive in a manner similar to the term “comprise”. Also, the term “exemplary” is merely meant as an example, rather than the best or optimal.

The devices and methods described herein may be used for various wireless communication networks such as Code Division Multiple Access (CDMA), Time Division Multiple Access (TDMA) and Frequency Division Multiple Access (FDMA) networks. The terms “network” and “system” are often used interchangeably. A CDMA network may implement a radio technology such as Universal Terrestrial Radio Access (UTRA), cdma2000, etc. UTRA includes Wideband-CDMA (W-CDMA) and other CDMA variants. Cdma2000 covers IS-2000, IS-95, and IS-856 standards. A TDMA network may implement a radio technology such as Global System for Mobile Communications (GSM) and derivatives thereof such as e.g. Enhanced Data Rate for GSM Evolution (EDGE), Enhanced General Packet Radio Service (EGPRS), etc. An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS).

In radio communications systems, a transmitter transmitting one or more radio communications signals on one or more radio communications channels may be present. In particular, the transmitter may be a base station or a transmitting device included in a user's device, such as a mobile radio transceiver, a handheld radio device or any similar device. Radio communications signals transmitted by transmitters may be received by receivers such as a receiving device in a mobile radio transceiver, a handheld radio device or any similar device. In particular, radio communications systems as disclosed herein may include UMTS systems which may conform to the 3GPP standard for UMTS systems. Radio communications signals as disclosed herein may be provided in UMTS systems, in particular over radio communications physical channels, such as primary common pilot channels, secondary common pilot channels, dedicated physical channels, dedicated physical control channels or similar channels according to the UMTS standard.

The devices and methods described herein may be applied in Multiple-Input Multiple-Output (MIMO) systems. Multiple-Input Multiple-Output (MIMO) wireless communication systems may employ multiple antennas at the transmitter and at the receiver to increase system capacity and to achieve better quality of service. In spatial multiplexing mode, MIMO systems may reach higher peak data rates without increasing the bandwidth of the system by transmitting multiple data streams in parallel in the same frequency band. A MIMO detector may be used for detecting the MIMO channel which may be described by the channel matrices between respective antennas of the transmitter and respective antennas of the receiver.

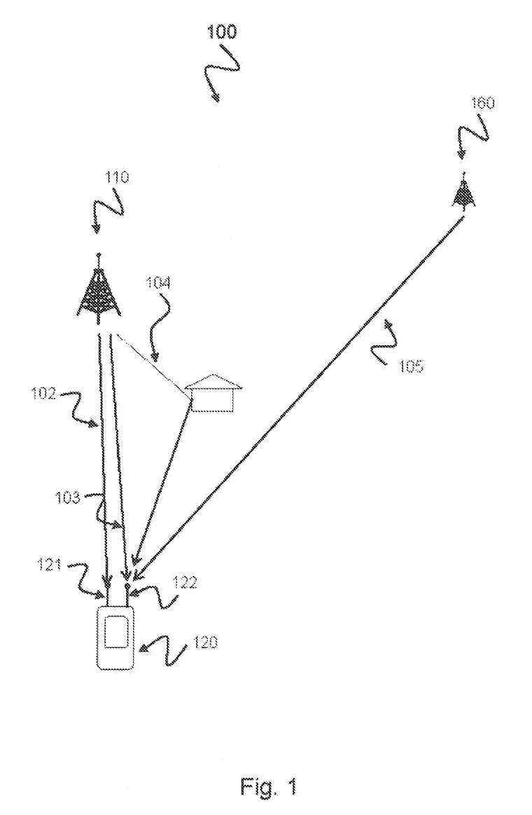

The devices and methods described herein may be applied in time-domain receivers such as rake receivers and other ones. Such receivers may use receiver taps, e.g. equalizer taps such as RAKE fingers for channel estimation and interference mitigation. A time-domain receiver such as a rake receiver is a radio receiver designed to counter the effects of multipath fading. This may be performed by using several “sub-receivers” called taps, receiver taps, equalizer taps, paths, fingers or RAKE fingers, that is, several correlators each assigned to a different multipath component. Each tap or finger may independently decode a single multipath component. At a later stage, the contribution of all taps or fingers may be combined in order to make the most use of the different transmission characteristics of each transmission path. This may result in higher signal-to-noise ratio (SNR) in a multipath environment. FIG. 1 depicts a wireless communications system 100 including a serving cell 110, e.g. a base station or NodeB, an interfering cell 160, e.g. another base station and a mobile receiver 120 with two or more antennas 121, 122, the mobile receiver 120 applying techniques for interference mitigation as described in this disclosure. The multipath channel through which a radio wave transmits from a base station 110 to a mobile station 120 can be viewed as transmitting the original (line-of-sight) wave pulse through a number of multipath components due to obstacles. Multipath components are delayed copies of the original transmitted wave traveling through a different echo path, each with a different magnitude and time-of-arrival at the receiver. Since each component contains the original information, if the magnitude and time-of-arrival (phase) of each component is computed at the receiver through a process called channel estimation, then all the components can be added coherently to improve the information reliability.

The rake receiver may be seen as the de-facto 3G receiver for demodulation of WCDMA signals. The principle of rake receivers may be to extract and combine a signal coming from different multi-path components in direct proportion to the signal energy present in those respective multi-path components. This principle may be widely dubbed as maximum ratio combining (MRC). The solution may apply verbatim to diversity rake with two receive antennas considering diversity fingers as independent fingers. This elegant rake solution may become sub-optimal in the presence of interference over multi-path components whether it is due to inter-cell or intra-cell signals. An improvement of diversity rake which is called Wiener Interference Cancellation (WIC) solution is described below. A WIC based rake receiver may be able to combat inter- and intra-cell interference for enhanced demodulation performance.

WIC is an algorithm in the receiver used for mitigating interference and thus increasing SINR and decreasing the block error rate (BLER). WIC evaluates signal and interference plus noise statistics in order to combine the received signal from two antennas in a beneficial manner. The signals from the two antennas are combined such that the resulting SNR is maximized. This may be understood as a way of beamforming: the receiver is tuned to “listen more closely” into the direction of the desired signal while the receiver is “made deaf” in the direction of the interference plus noise.

In the following a Wiener Interference Cancellation (WIC) scheme is described. The scheme refers to a Rake receiver having a plurality of sets of RAKE fingers each set receiving a radio signal from a different antenna. Under the assumption of same path-profiles seen at all the diversity antennas and interference being spatially correlated and temporally white, the WIC solution can be described as in the following:

The received signal for a particular path 1 after despreading can be denoted as

y₁=h₁x+e₁ (1)
with
x=scalar transmitted symbol, Nᵣₓ is the number of receive antennas
y₁ is the vector of received despread signal vector of dimension Nᵣₓ×1
h₁ is the vector channel coefficient of the path l of dimension Nᵣₓ×1
e₁ is the interference+noise vector of the path l of dimension Nᵣₓ×1

The main goal of WIC is to suppress the interference and noise vector e₁ whose covariance is structured and is denoted by R_{e,1}. Using the estimated covariance matrix the interference may be suppressed as follows:

$$\begin{matrix}{x}_{l} = {w}_{l}^{H} {y}_{l} = {h}_{l}^{H} {R}_{e , l}^{- 1} {y}_{l} \\ = {h}_{l}^{H} {R}_{e , l}^{- l} {h}_{l} x + {h}_{l}^{H} {R}_{e , l}^{- 1} {e}_{l}\end{matrix} \\ WIC demodulated symbol is {x}_{WIC} = {\sum }_{i = 1}^{{N}_{l}} {x}_{l} \qquad ( 2 )$$

Here, the vector w₁ is called WIC weight or WIC filter. The WIC filter applied to l-th finger requires corresponding channel estimates h₁ and spatial covariance matrix estimate R_{e,1} for this particular finger. These estimates are usually obtained by processing the common pilot channel (CPICH) of UMTS which can furnish h₁ and e₁ vectors.

It can be shown that the spatial covariance matrix R_{e,1} can be described like this:

$${R}_{e , l} = \frac{1}{SF} {\sum }_{{i = 1}_{i \neq l}}^{{N}_{taps}} {( \frac{{P}_{total}}{{P}_{CPICH}} )}_{c ( i )} {h}_{i} {h}_{i}^{H} + \frac{1}{SF} {σ}_{AWGN}^{2} I \qquad ( 3 )$$

Here, σ_{AWGN}² is the overall power of AWGN, and (Pₜₒₜₐₗ/P_{CPICH})_{c(i)} is the cell load parameter, which describes the ratio of the total transmit power of cell c divided by the transmit power of the CPICH (common pilot channel) of this cell. I is an identity matrix. Nₜₐₚₛ is the total number of radio channel taps (resolvable multipath components).

Wiener Interference Cancellation (WIC) is one technique to mitigate interference. However, as the algorithm of equation (3) works on a CPICH— (common pilot channel)—symbol-rate this technique is characterized by a relatively bad performance in high-speed scenarios because this relatively low rate is not high enough to allow for convergence of the algorithm when the user is moving quickly.

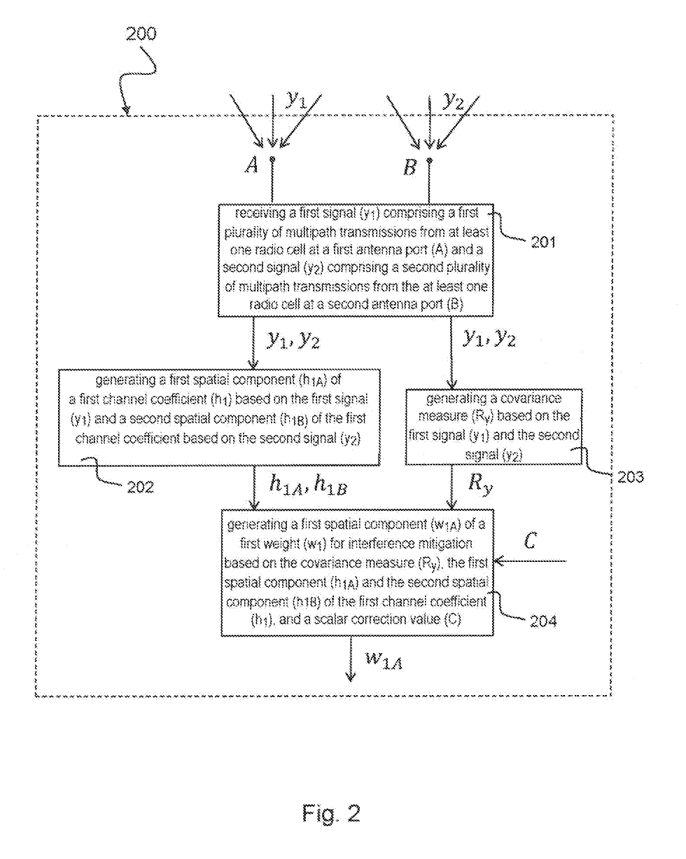

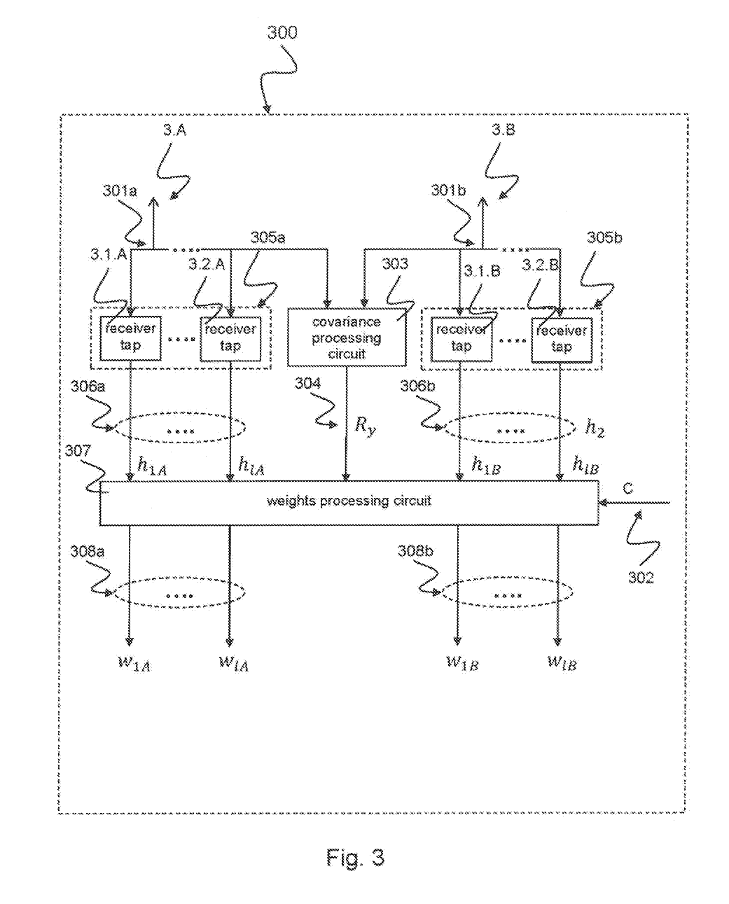

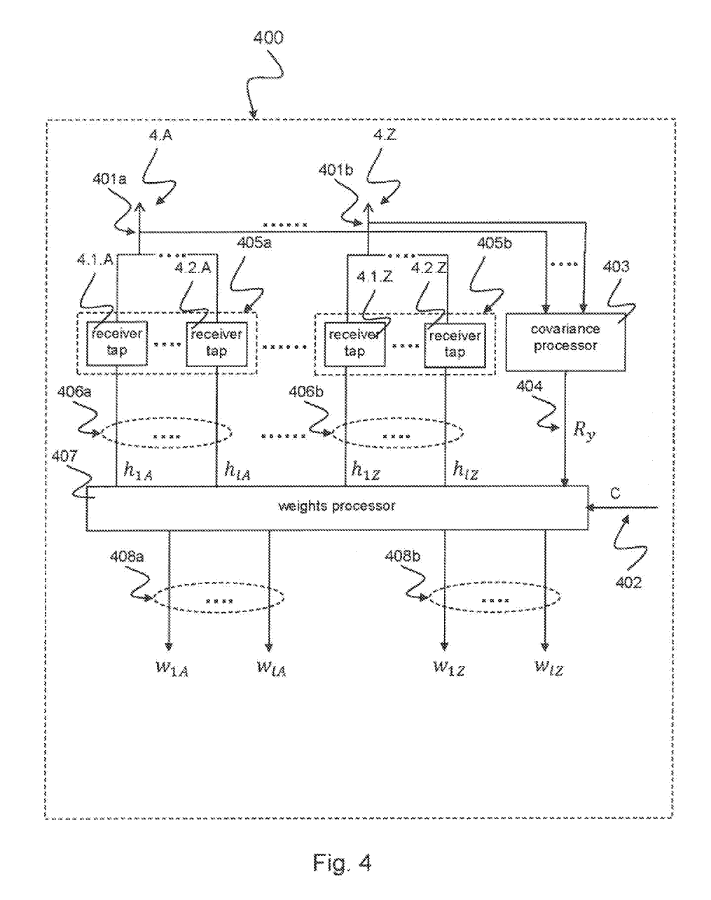

In this disclosure a new WIC-based algorithms is described that may work on a chip-rate instead of CPICH symbols. This means that in the same amount of time 256 times more information may be used for convergence. Therefore, convergence of the new WIC-based algorithm according to the disclosure can be achieved in high speed scenarios where the WIC algorithm (3) cannot converge quickly enough. The new WIC-based algorithm may be implemented by a method 200 as described below with respect to FIG. 2 or by an interference mitigating receiver circuit 300 according to FIG. 3 or by an interference mitigating receiver 400 according to FIG. 4.

FIG. 2 schematically illustrates a method 200 for mitigating interference in accordance with the disclosure.

The method 200 includes receiving 201 a first signal y₁ comprising a first plurality of multipath transmissions from at least one radio cell at a first antenna port A and a second signal y₂ comprising a second plurality of multipath transmissions from the at least one radio cell at a second antenna port B. The method 200 includes generating 202 a first spatial component h_{1A} of a first channel coefficient h₁ based on the first signal y₁ and a second spatial component h_{1B} of the first channel coefficient h₁ based on the second signal y₂. The method 200 includes generating 203 a covariance measure R_{y} based on the first signal y₁ and the second signal y₂. The method 200 includes generating 204 a first spatial component w_{1A} of a first weight w₁ for interference mitigation based on the covariance measure R_{y}, the first spatial component h_{1A} and the second spatial component h_{1B} of the first channel coefficient h₁ and a scalar correction value C. The generating 202 of the first and second spatial components h_{1A}, h_{1B} of the first channel coefficient h₁ and the generating 203 of the covariance measure may be performed in parallel or either one of the two generating blocks 202, 203 may be performed first.

The method 200 may further include mitigating or cancelling an interference at the first antenna port by applying the first spatial component w_{1A} of the first weight to the first signal y₁. The method 200 may further include updating the covariance measure R_{y} and the first spatial component w_{1A} of the first weight w₁ for interference mitigation on a chip-rate basis.

The covariance measure R_{y} may be a spatial covariance matrix of the first signal y₁ received at the first antenna port A and the second signal y₂ received at the second antenna port B.

The method 200 may further include generating a second spatial component w_{1B} of the first weight w₁ for interference mitigation based on the covariance measure R_{y}, the first and second spatial components h_{1A}, h_{1B} of the first channel coefficient h₁ and the scalar correction value C. The method 200 may further include mitigating or cancelling interference at the second antenna port B by applying the second spatial component w_{1B} of the first weight w₁ to the second signal y₂.

The scalar correction value C of the method 200 may be a multiplicative correction factor applied to one of the first channel coefficient h₁ and an inverse of the covariance measure R_{y}. The scalar correction value C may be based on a spreading factor SF of the at least one radio cell. The scalar correction value C may be based on a cell load of the at least one radio cell.

The cell load of the at least one radio cell may be generated based on a ratio of a total transmit power Pₜₒₜₐₗ of the at least one radio cell and a transmit power P_{CPICH} of a common pilot channel of the at least one radio cell.

The scalar correction value C may further be based on the term h₁^{H}R_{y}⁻¹h₁, wherein h₁ is a vector of the first channel coefficient, h₁^{H} is a vector of the Hermitian values of the first channel coefficient and R_{y}⁻¹ is an inverse matrix of the covariance measure which is formed as a matrix.

The method 200 may further include generating the first weight w₁ for interference mitigation based on a multiplication of the scalar correction value C with the term R_{y}⁻¹h₁, wherein h₁ is a vector of the first channel coefficient and R_{y}⁻¹ is an inverse matrix of the covariance measure which is formed as a matrix.

The method 200 may further include generating the first weight w₁ for interference mitigation based on the relation:

$${w}_{1} = {SF ( 1 - {( \frac{{P}_{total}}{{P}_{CPICH}} )}_{c ( 1 )} {h}_{1}^{H} {R}_{y}^{- 1} {h}_{1} )}^{- 1} {R}_{y}^{- 1} {h}_{1} ,$$

wherein h₁ is a vector of the first channel coefficient, R_{y}⁻¹ is an inverse matrix of the covariance measure which is formed as a matrix, SF is a spreading factor of the radio cell c(1) related with the first antenna port and

$$( {( \frac{{P}_{total}}{{P}_{CPICH}} )}_{c ( 1 )} )$$

is the cell load of the radio cell c(1).

The method 200 as described above may be derived from a new representation of the spatial covariance matrix R_{e,1} according to the above equation (3) as described in the following. The spatial covariance matrix of the I/Q-sample stream (the input to the rake receiver) can be shown to have a relatively similar expression:

$${R}_{y} = {\sum }_{i = 1}^{{N}_{tops}} {( \frac{{P}_{total}}{{P}_{CPICH}} )}_{c ( i )} {h}_{i} {h}_{i}^{H} + {σ}_{AWGN}^{2} I = SF \cdot {R}_{e , l} + {( \frac{{P}_{total}}{{P}_{CPICH}} )}_{c ( l )} {h}_{l} {h}_{l}^{H} \qquad ( 4 )$$

Solving this equation (4) for R_{e,1} yields a different representation for the spatial covariance matrix R_{e,1} that is required for optimal WIC weight calculation:

$${R}_{e , l} = \frac{1}{SF} ( {R}_{y} - {( \frac{{P}_{total}}{{P}_{CPICH}} )}_{c ( l )} {h}_{l} {h}_{l}^{H} ) \qquad ( 5 )$$

With this representation (5) it can be seen that a calculation of R_{e,1} (required for computation of the WIC weights as shown in equation (2)) requires only a channel estimate h₁, an estimate of the cell load parameter (Pₜₒₜₐₗ/P_{CPICH})_{c(i)} for every cell in the active set, and an estimate of the spatial covariance matrix of the I/Q-sample stream R_{y}. A high-quality channel estimate is typically already available in all receivers for WCDMA, furthermore there are robust algorithms available to estimate the cell load parameter. Estimating the spatial covariance matrix of the I/Q-sample stream can be implemented via simple averaging over time and due to the very high rate of I/Q-samples (e.g. one every 260 ns) this estimation can be performed with high accuracy even in scenarios with a low coherence time of this variable.

Using this representation (5) to calculate the optimal WIC weights yields:

$${w}_{l} = {R}_{e , l}^{- 1} {h}_{l} = {SF ( {R}_{y} - {( \frac{{P}_{total}}{{P}_{CPICH}} )}_{c ( l )} {h}_{l} {h}_{l}^{H} )}^{- 1} {h}_{l} \qquad ( 6 )$$

Applying the matrix inversion lemma to equation (6) may be used to come to a different implementation:

$${w}_{l} = {SF ( 1 - {( \frac{{P}_{total}}{{P}_{CPICH}} )}_{c ( l )} {h}_{l}^{H} {R}_{y}^{- 1} {h}_{l} )}^{- 1} {R}_{y}^{- 1} {h}_{l} \qquad ( 7 )$$

With this representation (7) of the optimal WIC weight, the matrix R_{y} may be inverted first, and then multiplied with a scalar factor, whereas in the previous representation (6) the matrix is modified by subtracting an outer product and then inverted. Please observe that the big expression in the parentheses of equation (7) is a scalar. The scalar factor is denoted as C in the method 200 as described above.

For an implementation, the later expression (7) is better suited since subtracting an outer product from a positive semidefinite matrix in (6) may lead to the loss of positive semidefiniteness and ensuing numerical problems, whereas these problems may be avoided in the later expression (7) when making sure that the scalar factor lies between 0 and 1. The implementation of equation (7) is denoted as semi-parametric WIC implementation in the following. This semi-parametric WIC implementation may be computed for each chip, i.e. with the rate of the spreading code.

The method 200 is not limited to interferers based on WCDMA signals comprising e.g. of a SCH and a CPICH channel. The method 200 also works for generic spatially colored noise.

FIG. 3 schematically illustrates an interference mitigating receiver circuit 300 in accordance with the disclosure.

The interference mitigating receiver circuit 300 includes a first antenna port 3.A, a second antenna port 3.B, a first set of receiver taps 305a, a second set of receiver taps 305b, a covariance processing circuit 303 and a weights processing circuit 307. The first antenna port 3.A may receive a first signal 301a comprising multipath transmissions from at least one radio cell, e.g. a serving radio cell 110 and one or more interfering radio cells 160 as described above with respect to FIG. 1. The second antenna port 3.B may receive a second signal 301b comprising multipath transmissions from the at least one radio cell. The first set of receiver taps 305a may include a plurality of receiver taps 3.1.A, 3.2.A as depicted in FIG. 3 that may be implemented as Rake fingers, for example. The receiver taps 3.1.A, 3.2.A may be coupled to the first antenna port 3.A for generating first spatial components 306a of a set of channel coefficients 306a, 306b (also denoted as h₁, i.e. first channel coefficients vector according to equation (1) above) based on the first signal 301a. The receiver taps 3.1.B, 3.2.B may be coupled to the second antenna port 3.B for generating second spatial components 306b of the set of channel coefficients 306a, 306b based on the second signal 301b.

The covariance processing circuit 303 may process a covariance measure 304 based on the first signal 301a and the second signal 301b, e.g. the spatial covariance matrix of the vector of the first signal 301a and the vector of the second signal 301b, for example the spatial covariance matrix of the I/Q-sample stream that is the input to the rake receiver.

The weights processing circuit 307 may generate first spatial components 308a of a set of weights 308a, 308b for interference mitigation based on the covariance measure 304, the first and second spatial components 306a, 306b of the set of channel coefficients 306a, 306b and a scalar correction value C 302.

The covariance measure R_{y} may be a spatial covariance matrix of the first signal y₁ received at the first antenna port and the second signal y₂ received at the second antenna port as described above with respect to FIG. 2.

The interference mitigating receiver circuit 300 may include an interference cancellation circuit (not depicted in FIG. 3) to cancel interference at the first antenna port 3.A by applying the first spatial components 308a of the set of weights 308a, 308b to the first signal 301a.

The covariance processing circuit 303 may update the covariance measure 304 and the first spatial components 308a of the set of weights 308a, 308b for interference mitigation on a chip-rate basis. The interference cancellation circuit may cancel the interference per chip-rate.

The weights processing circuit 307 may generate second spatial components 308b of the set of weights 308a, 308b for interference mitigation based on the covariance measure 304, the first and second spatial components 306a, 306b of the set of channel coefficients 306a, 306b and the scalar correction value C 302.

The interference cancellation circuit may cancel interference and noise at the second antenna port 3.B by applying the second spatial components 308b of the set of weights 308a, 308b to the second signal 301b.

The scalar correction value C may be defined as described above with respect to FIG. 2. The scalar correction factor may be a multiplicative correction factor applied to the set of channel coefficients 306a, 306b or to an inverse of the covariance measure R_{y}. The scalar correction value C may be based on a spreading factor SF of the at least one radio cell. The scalar correction value C may be based on a cell load of the at least one radio cell.

The cell load of the at least one radio cell may be generated based on a ratio of a total transmit power Pₜₒₜₐₗ of the at least one radio cell and a transmit power P_{CPICH} of a common pilot channel of the at least one radio cell.

The scalar correction value C may further be based on the term h₁^{H}R_{y}⁻¹h₁, wherein h₁ is a vector of the set of channel coefficients, h₁^{H} is a vector of the set of Hermitian values of the set of channel coefficients and R_{y}⁻¹ is an inverse matrix of the covariance measure which is formed as a matrix.

The weights processing circuit 307 may generate the set of weights w₁ for interference mitigation based on a multiplication of the scalar correction value C with the term R_{y}⁻¹h₁, wherein h₁ is a vector of the set of channel coefficients and R_{y}⁻¹ is an inverse matrix of the covariance measure which is formed as a matrix.

The weights processing circuit 307 may generate the first spatial components 308 of the set of weights w₁ for interference mitigation based on the relation:

$${w}_{1} = {SF ( 1 - {( \frac{{P}_{total}}{{P}_{CPICH}} )}_{c ( 1 )} {h}_{1}^{H} {R}_{y}^{- 1} {h}_{1} )}^{- 1} {R}_{y}^{- 1} {h}_{1} ,$$

wherein h₁ is a vector of the set of channel coefficients, R_{y}⁻¹ is an inverse matrix of the covariance measure which is formed as a matrix, SF is a spreading factor of the radio cell c(1) related with the first antenna port and

$$( {( \frac{{P}_{total}}{{P}_{CPICH}} )}_{c ( 1 )} )$$

is the cell load of the radio cell c(1).

The structure of the device 300 may realize an implementation of the semi-parametric WIC technique as described above with respect to equation (7). The interference mitigating receiver circuit 300 may operate on a chip-rate.

FIG. 4 schematically illustrates an interference mitigating receiver 400 in accordance with the disclosure.

The interference mitigating receiver 400 includes a plurality of antenna ports 4.A, 4.Z, a plurality of sets of receiver taps 405a, 405b, a covariance processor 403 and a weights processor 407. The plurality of antenna ports 4.A, 4.Z may receive a corresponding plurality of radio signals 401a, 401b each radio signal comprising multipath transmissions. The plurality of radio signals 401a, 401b may be received from a plurality of radio cells, e.g. a serving radio cell 110 and one or more interfering radio cells 160 as described above with respect to FIG. 1. A first set of receiver taps 405a may include a plurality of first receiver taps 4.1.A, 4.2.A as depicted in FIG. 4 that may be implemented as Rake fingers, for example. An l-th set of receiver taps 405b may include a plurality of l-th receiver taps 4.1.Z, 4.2.Z as depicted in FIG. 4 that may be implemented as Rake fingers, for example. The index l may be defined according to equation (1) above and may range from 1 to an upper integer number. Every set of the plurality of sets of receiver taps 405a, 405b may be coupled to a respective one of the plurality of antenna ports 4.A, 4.Z for generating a respective spatial component 406a, 406b of a set of channel coefficients based on the radio signal 401a, 401b of the respective antenna port 4.A, 4.Z.

The covariance processor 403 may generate a covariance measure 404 based on the plurality of radio signals 401a, 401b, e.g. the spatial covariance matrix of the vector of the first signal 301a and the vector of the second signal 301b as described with respect to FIG. 2, for example the spatial covariance matrix of the I/Q-sample stream that is the input to the rake receiver.

The weights processor 407 may generate for each antenna port 4.A, 4.Z a respective spatial component of a set of weights 408a, 408b for interference mitigation based on the covariance measure 404, the spatial components 406a, 406b of the set of channel coefficients and a scalar correction value C 402. The weights processor 407 may generate the weights according to equation (7) described above with respect to FIG. 2.

The interference cancellation circuit may cancel interference and noise at the plurality of antenna ports 4.A, 4.Z by applying the set of weights 408a, 408b to the plurality of radio signals 401a, 401b on a chip-rate basis. Each set of receiver taps 405a, 405b may include a set of Rake fingers.

The scalar correction value C may be defined as described above with respect to FIGS. 2 and 3.

The structure of the device 400 may realize an implementation of the semi-parametric WIC technique as described above with respect to equation (7). The interference mitigating receiver 400 may operate on a chip-rate.

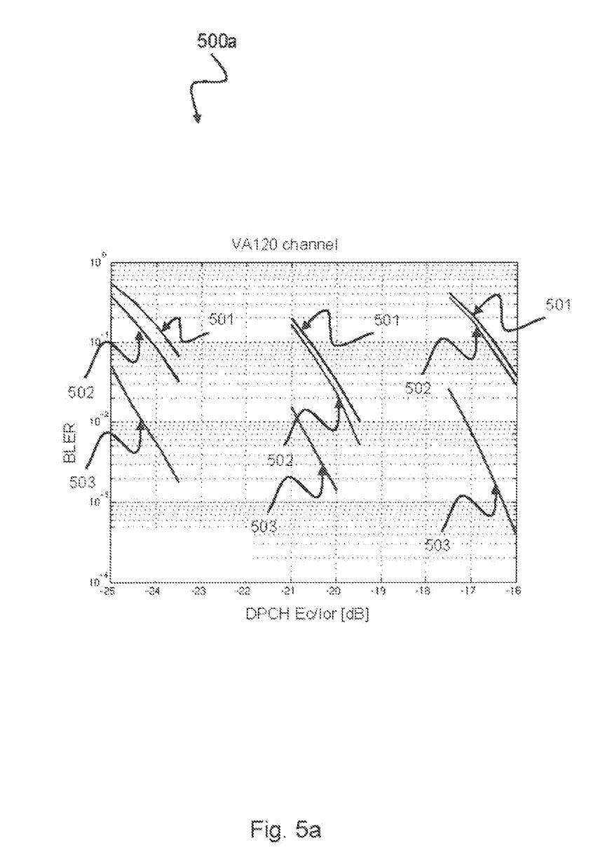

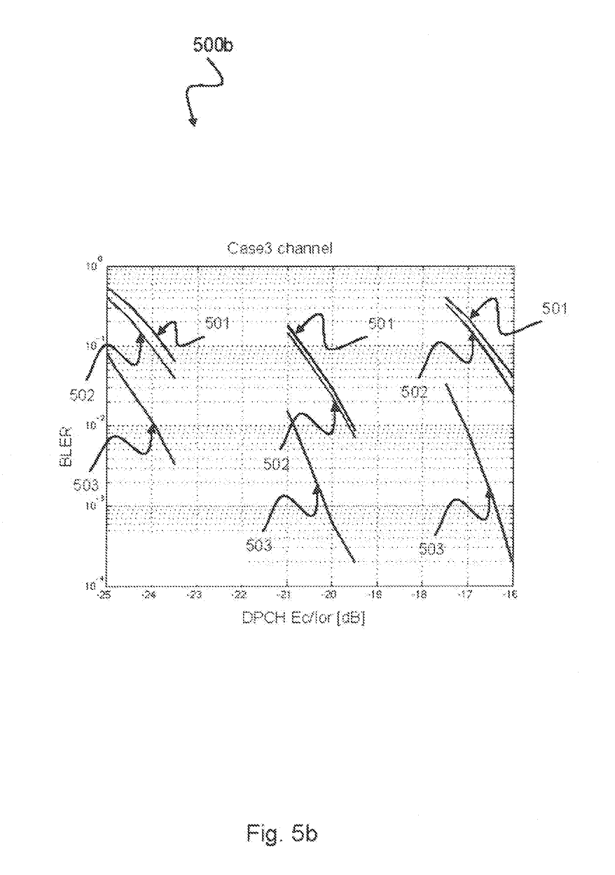

FIGS. 5a and 5b illustrate exemplary performance diagrams 500a, 500b illustrating block error rates for a VA120 channel (FIG. 5a) and a Case3 channel (FIG. 5b) when using different interference mitigation techniques. The curves 501 denotes a usual Rake receiver implementation, the curves 502 denote a WIC implementation according to equation (3) as described above with respect to FIG. 2 and the curves 503 denote the new semi-parametric WIC implementation according to equation (7) as described above with respect to FIG. 2.

The WIC implementation 502 according to equation (3) works by evaluating measurements done on the despreaded CPICH symbols. These measurements can only be updated once per CPICH symbol (256 chips), because this is the rate with which pilot symbols are received. Obtaining noise plus interference statistics is done by evaluating variance and correlation of the despreaded CPICH symbols, which means that the algorithm requires several to a few dozen CPICH symbols in order to obtain a precise enough estimate.

Via the new representation of the WIC algorithm 503, i.e. according to equation (7) above obtaining the noise plus interference statistics is possible by evaluating variance and correlation on the I/Q-samples which happen with a factor of 256 faster than CPICH symbols. Because of this, a convergence of this algorithm is significantly faster. This allows for good convergence also in rapidly changing radio conditions such as those when moving quickly (120 km/h). Here, both the rake receiver algorithm 501 and the WIC algorithm 502 do not converge anymore, leading to poor performance as can be seen from FIGS. 5a and 5b.

### Examples

The following examples pertain to further embodiments. Example 1 is a method for mitigating interference, the method comprising: receiving a first signal comprising a first plurality of multipath transmissions from at least one radio cell at a first antenna port and a second signal comprising a second plurality of multipath transmissions from the at least one radio cell at a second antenna port; generating a first spatial component of a first channel coefficient based on the first signal and a second spatial component of the first channel coefficient based on the second signal; generating a covariance measure based on the first signal and the second signal; and generating a first spatial component of a first weight for interference mitigation based on the covariance measure, the first spatial component and the second spatial component of the first channel coefficients (h₁), and a scalar correction value.

In Example 2, the subject matter of Example 1 can optionally include mitigating an interference at the first antenna port by applying the first spatial component of the first weight to the first signal.

In Example 3, the subject matter of any one of Examples 1-2 can optionally include updating the covariance measure and the first spatial component of the first weight for interference mitigation on a chip-rate basis.

In Example 4, the subject matter of any one of Examples 1-3 can optionally include that the covariance measure is a spatial covariance matrix of the first signal received at the first antenna port and the second signal received at the second antenna port.

In Example 5, the subject matter of any one of Examples 1-4 can optionally include generating a second spatial component of the first weight for interference mitigation based on the covariance measure, the first and second spatial components of the first channel coefficient and the scalar correction value.

In Example 6, the subject matter of Example 5 can optionally include mitigating an interference at the second antenna port by applying the second spatial component of the first weight to the second signal.

In Example 7, the subject matter of any one of Examples 1-6 can optionally include that the scalar correction value is a multiplicative correction factor applied to one of the first channel coefficient and an inverse of the covariance measure.

In Example 8, the subject matter of any one of Examples 1-7 can optionally include that the scalar correction value is based on a spreading factor of the at least one radio cell.

In Example 9, the subject matter of any one of Examples 1-8 can optionally include that the scalar correction value is based on a cell load of the at least one radio cell.

In Example 10, the subject matter of Example 9 can optionally include that the cell load of the at least one radio cell is generated based on a ratio of a total transmit power of the at least one radio cell and a transmit power of a common pilot channel of the at least one radio cell.

In Example 11, the subject matter of any one of Examples 1-10 can optionally include that the scalar correction value is based on the term h₁^{H}R_{y}⁻¹h₁, wherein h₁ is a vector of the first channel coefficient, h₁^{H} is a vector of the Hermitian values of the first channel coefficient and R_{y}⁻¹ is an inverse matrix of the covariance measure which is formed as a matrix.

In Example 12, the subject matter of any one of Examples 1-11 can optionally include generating the first weight for interference mitigation based on a multiplication of the scalar correction value with the term R_{y}⁻¹h₁, wherein h₁ is a vector of the first channel coefficient and R_{y}⁻¹ is an inverse matrix of the covariance measure which is formed as a matrix.

In Example 13, the subject matter of any one of Examples 1-12 can optionally include generating the first weight for interference mitigation based on the relation:

$${w}_{1} = {SF ( 1 - {( \frac{{P}_{total}}{{P}_{CPICH}} )}_{c ( 1 )} {h}_{1}^{H} {R}_{y}^{- 1} {h}_{1} )}^{- 1} {R}_{y}^{- 1} {h}_{1} ,$$

wherein h₁ is a vector of the first channel coefficient, R_{y}⁻¹ is an inverse matrix of the covariance measure which is formed as a matrix, SF is a spreading factor of the radio cell c(1) related with the first antenna port and

$$( {( \frac{{P}_{total}}{{P}_{CPICH}} )}_{c ( 1 )} )$$

is the cell load of the radio cell c(1).

Example 14 is an interference mitigating receiver circuit, comprising: a first antenna port configured to receive a first signal comprising multipath transmissions from at least one radio cell; a second antenna port configured to receive a second signal comprising multipath transmissions from the at least one radio cell; a first set of receiver taps coupled to the first antenna port and configured to generate first spatial components of a set of channel coefficients based on the first signal; a second set of receiver taps coupled to the second antenna port and configured to generate second spatial components of the set of channel coefficients based on the second signal; a covariance processing circuit configured to generate a covariance measure based on the first signal and the second signal; and a weights processing circuit configured to generate first spatial components of a set of weights for interference mitigation based on the covariance measure, the first and second spatial components of the set of channel coefficients and a scalar correction value.

In Example 15, the subject matter of Example 14 can optionally include an interference cancellation circuit configured to cancel an interference at the first antenna port by applying the first spatial components of the set of weights to the first signal.

In Example 16, the subject matter of Example 15 can optionally include that the covariance processing circuit is configured to update the covariance measure and the first spatial components of the set of weights for interference mitigation on a chip-rate basis; and that the interference cancellation circuit is configured to cancel the interference per chip-rate.

In Example 17, the subject matter of any one of Examples 14-16 can optionally include a circuitry that is configured to apply the scalar correction value as a multiplicative correction factor to one of the set of channel coefficients and an inverse of the covariance measure.

In Example 18, the subject matter of any one of Examples 14-17 can optionally include a circuitry that is configured to apply the scalar correction value based on a spreading factor of the at least one radio cell.

In Example 19, the subject matter of any one of Examples 14-18 can optionally include a circuitry that is configured to apply the scalar correction value based on a cell load of the at least one radio cell.

In Example 20, the subject matter of any one of Examples 14-19 can optionally include that the weights processing circuit is configured to generate second spatial components of the set of weights for interference mitigation based on the covariance measure, the first and second spatial components of the set of channel coefficients and the scalar correction value.

In Example 21, the subject matter of Example 20 can optionally include that the interference cancellation circuit is configured to cancel an interference at the second antenna port by applying the second spatial components of the set of weights to the second signal.

Example 22 is an interference mitigating receiver, comprising: a plurality of antenna ports configured to receive a corresponding plurality of radio signals each radio signal comprising multipath transmissions; a plurality of sets of receiver taps each set coupled to a respective one of the plurality of antenna ports configured to generate a respective spatial component of a set of channel coefficients based on the radio signal of the respective antenna port; a covariance processor configured to generate a covariance measure based on the plurality of radio signals; and a weights processor configured to generate for each antenna port a respective spatial component of a set of weights for interference mitigation based on the covariance measure, the spatial components of the sets of channel coefficients and a scalar correction value.

In Example 23, the subject matter of Example 22 can optionally include an interference cancellation circuit configured to cancel an interference at the plurality of antenna ports by applying the set of weights to the plurality of radio signals on a chip-rate basis.

In Example 24, the subject matter of any one of Examples 22-23 can optionally include that each set of receiver taps comprises a set of Rake fingers.

In Example 25, the subject matter of any one of Examples 22-24 can optionally include a circuitry configure to generate the scalar correction value as a multiplicative correction factor that depends on a spreading factor of at least one radio cell generating the plurality of radio signals and that depends on a cell load of the at least one radio cell.

Example 26 is a computer readable medium on which computer instructions are stored which when executed by a computer, cause the computer to perform the method of one of Examples 1 to 13.

In Example 27, the subject matter of any one of Examples 14-21 can optionally include that the weights processing circuit is configured to generate the first spatial components of the set of weights based on a multiplicative correction factor applied to one of the first and second spatial components of the set of channel coefficients or an inverse of the covariance measure.

In Example 28, the subject matter of any one of Examples 14-21 can optionally include that the weights processing circuit is configured to generate the first spatial components of the set of weights based on a spreading factor of the at least one radio cell.

In Example 29, the subject matter of any one of Examples 14-21 can optionally include that the weights processing circuit is configured to generate the first spatial components of the set of weights based on a cell load of the at least one radio cell.

In Example 30, the subject matter of Example 29 can optionally include that the weights processing circuit is configured to generate the cell load of the at least one radio cell based on a ratio of a total transmit power of the at least one radio cell and a transmit power of a common pilot channel of the at least one radio cell.

In Example 31, the subject matter of any one of Examples 14-21 can optionally include that the weights processing circuit is configured to generate the first spatial components of the set of weights based on a the term h₁^{H}R_{y}⁻¹h₁, wherein h₁ is a vector of the set of channel coefficients, h₁^{H} is a vector of the set of Hermitian values of the set of channel coefficients and R_{y}⁻¹ is an inverse matrix of the covariance measure which is formed as a matrix.

In Example 32, the subject matter of any one of Examples 14-21 can optionally include that the weights processing circuit is configured to generate the first spatial components of the set of weights for interference mitigation based on a multiplication of the scalar correction value with the term R_{y}⁻¹h₁, wherein h₁ is a vector of the set of channel coefficients and R_{y}⁻¹ is an inverse matrix of the covariance measure which is formed as a matrix.

In Example 33, the subject matter of any one of Examples 14-21 can optionally include that the weights processing circuit is configured to generate the first spatial components of the set of weights for interference mitigation based on the relation:

$${w}_{1} = {SF ( 1 - {( \frac{{P}_{total}}{{P}_{CPICH}} )}_{c ( 1 )} {h}_{1}^{H} {R}_{y}^{- 1} {h}_{1} )}^{- 1} {R}_{y}^{- 1} {h}_{1} ,$$

wherein h₁ is a vector of the set of channel coefficients, R_{y}⁻¹ is an inverse matrix of the covariance measure which is formed as a matrix, SF is a spreading factor of the radio cell c(1) related with the first antenna port and

$$( {( \frac{{P}_{total}}{{P}_{CPICH}} )}_{c ( 1 )} )$$

is the cell load of the radio cell c(1).

In Example 34, the subject matter of Example 19 can optionally include that the weights processing circuit is configured to receive the cell load of the at least one radio cell from a network.

In Example 35, the subject matter of any one of Examples 22-25 can optionally include that the weights processor is configured to generate the spatial components of the sets of weights based on a multiplicative correction factor applied to the set of channel coefficients or applied to an inverse of the covariance measure.

In Example 36, the subject matter of any one of Examples 22-25 can optionally include that the weights processor is configured to generate the spatial components of the set of weights based on a spreading factor of the at least one radio cell.

In Example 37, the subject matter of any one of Examples 22-25 can optionally include that the weights processor is configured to generate the spatial components of the set of weights based on a cell load of the at least one radio cell.

In Example 38, the subject matter of Example 37 can optionally include that the weights processor is configured to generate the cell load of the at least one radio cell based on a ratio of a total transmit power of the at least one radio cell and a transmit power of a common pilot channel of the at least one radio cell.

In Example 39, the subject matter of any one of Examples 22-25 can optionally include that the weights processor is configured to generate the spatial components of the set of weights based on a the term h₁^{H}R_{y}⁻¹h₁, wherein h₁ is a vector of the l-th channel coefficient, h₁^{H} is a vector of the Hermitian value of the l-th channel coefficient and R_{y}⁻¹ is an inverse matrix of the covariance measure which is formed as a matrix.

In Example 40, the subject matter of any one of Examples 22-25 can optionally include that the weights processor is configured to generate the spatial components of the set of weights for interference mitigation based on a multiplication of the scalar correction value with the term R_{y}⁻¹h₁, wherein h₁ is a vector of the l-th channel coefficient and R_{y}⁻¹ is an inverse matrix of the covariance measure which is formed as a matrix.

In Example 41, the subject matter of any one of Examples 22-25 can optionally include that the weights processor is configured to generate the spatial components of the set of weights for interference mitigation based on the relation:

$${w}_{1} = {SF ( 1 - {( \frac{{P}_{total}}{{P}_{CPICH}} )}_{c ( 1 )} {h}_{1}^{H} {R}_{y}^{- 1} {h}_{1} )}^{- 1} {R}_{y}^{- 1} {h}_{1} ,$$

wherein h₁ is a vector of the l-th channel coefficient, R_{y}⁻¹ is an inverse matrix of the covariance measure which is formed as a matrix, SF is a spreading factor of the radio cell c(1) related with the l-th antenna port and

$$( {( \frac{{P}_{total}}{{P}_{CPICH}} )}_{c ( 1 )} )$$

is the cell load of the radio cell c(1).

In Example 42, the subject matter of Example 37 can optionally include that the weights processor is configured to receive the cell load of the at least one radio cell from a network.

Example 43 is a device for mitigating interference, the device comprising: means for receiving a first signal comprising a first plurality of multipath transmissions from at least one radio cell at a first antenna port and a second signal comprising a second plurality of multipath transmissions from the at least one radio cell at a second antenna port; means for generating a first spatial component of a first channel coefficient based on the first signal and for generating a second spatial component of the first channel coefficient based on the second signal; means for generating a covariance measure based on the first signal and the second signal; and means for generating a first spatial component of a first weight for interference mitigation based on the covariance measure, the first spatial component and the second spatial component of the first channel coefficient and a scalar correction value.

In Example 44, the subject matter of Example 43 can optionally include means for mitigating an interference at the first antenna port by applying the first spatial component of the first weight to the first signal.

In Example 45, the subject matter of any one of Examples 43-44 can optionally include means for updating the covariance measure and the first spatial component of the first weight for interference mitigation on a chip-rate basis.

In Example 46, the subject matter of any one of Examples 43-45 can optionally include that the covariance measure is a spatial covariance matrix of the first signal received at the first antenna port and the second signal received at the second antenna port.

In Example 47, the subject matter of any one of Examples 43-46 can optionally include means for generating a second spatial component of the first weight for interference mitigation based on the covariance measure, the first and second spatial components of the first channel coefficient and the scalar correction value.

In Example 48, the subject matter of Example 47 can optionally include means for mitigating an interference at the second antenna port by applying the second spatial component of the first weight to the second signal.

In Example 49, the subject matter of any one of Examples 43-48 can optionally include that the scalar correction value is a multiplicative correction factor applied to one of the first channel coefficient and an inverse of the covariance measure.

In Example 50, the subject matter of any one of Examples 43-48 can optionally include that the scalar correction value is based on a spreading factor of the at least one radio cell.

In Example 51, the subject matter of any one of Examples 43-50 can optionally include that the scalar correction value is based on a cell load of the at least one radio cell.

In Example 52, the subject matter of Example 51 can optionally include means for generating the cell load of the at least one radio cell based on a ratio of a total transmit power of the at least one radio cell and a transmit power of a common pilot channel of the at least one radio cell.

In Example 53, the subject matter of Example 51 or Example 52 can optionally include means for receiving the cell load from a network.

In Example 54, the subject matter of any one of Examples 43-53 can optionally include that the scalar correction value is based on the term h₁^{H}R_{y}⁻¹h₁, wherein h₁ is a vector of the first channel coefficient, h₁^{H} is a vector of the Hermitian value of the first channel coefficient and R_{y}⁻¹ is an inverse matrix of the covariance measure which is formed as a matrix.

In Example 55, the subject matter of any one of Examples 43-54 can optionally include means for generating the first weight for interference mitigation based on a multiplication of the scalar correction value with the term R_{y}⁻¹h₁, wherein h₁ is a vector of the first channel coefficient and R_{y}⁻¹ is an inverse matrix of the covariance measure which is formed as a matrix.

In Example 56, the subject matter of any one of Examples 43-55 can optionally include means for generating the first weight for interference mitigation based on the relation:

$${w}_{1} = {SF ( 1 - {( \frac{{P}_{total}}{{P}_{CPICH}} )}_{c ( 1 )} {h}_{1}^{H} {R}_{y}^{- 1} {h}_{1} )}^{- 1} {R}_{y}^{- 1} {h}_{1} ,$$

wherein h₁ is a vector of the first channel coefficient, R_{y}⁻¹ is an inverse matrix of the covariance measure which is formed as a matrix, SF is a spreading factor of the radio cell c(1) related with the first antenna port and

$$( {( \frac{{P}_{total}}{{P}_{CPICH}} )}_{c ( 1 )} )$$

is the cell load of the radio cell c(1).

Example 57 is an interference cancelling system, comprising: a plurality of antenna ports configured to receive a corresponding plurality of radio signals each radio signal comprising multipath transmissions; a plurality of sets of receiver taps each set coupled to a respective one of the plurality of antenna ports and configured to generating a respective spatial component of a set of channel coefficients based on the radio signal of the respective antenna port; a covariance processor configured to generate a covariance measure based on the plurality of radio signals; and a weights processor configured to generate for each antenna port a respective spatial component of a set of weights for interference mitigation based on the covariance measure, the spatial components of the set of channel coefficients and a scalar correction value.

In Example 58, the subject matter of Example 57 can optionally include an interference cancellation circuit configured to cancel an interference at the plurality of antenna ports by applying the set of weights to the plurality of radio signals on a chip-rate basis.

In Example 59, the subject matter of any one of Examples 57-58 can optionally include that each set of receiver taps comprises a set of Rake fingers.

In Example 60, the subject matter of any one of Examples 57-59 can optionally include that the scalar correction value is a multiplicative correction factor depending on a spreading factor of at least one radio cell generating the plurality of radio signals and depending on a cell load of the at least one radio cell.

In Example 61, the subject matter of any one of Examples 57-60 can optionally include that the system is an on-chip system.

In addition, while a particular feature or aspect of the disclosure may have been disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Furthermore, it is understood that aspects of the disclosure may be implemented in discrete circuits, partially integrated circuits or fully integrated circuits or programming means. Also, the terms “exemplary”, “for example” and “e.g.” are merely meant as an example, rather than the best or optimal.

Although specific aspects have been illustrated and described herein, it will be appreciated by those of ordinary skill in the art that a variety of alternate and/or equivalent implementations may be substituted for the specific aspects shown and described without departing from the scope of the present disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

1-25. (canceled)

26. A method for mitigating interference, the method comprising:
receiving a first signal comprising a first plurality of multipath transmissions from at least one radio cell at a first antenna port and a second signal comprising a second plurality of multipath transmissions from the at least one radio cell at a second antenna port;
generating a first spatial component of a first channel coefficient based on the first signal and a second spatial component of the first channel coefficient based on the second signal;
generating a covariance measure based on the first signal and the second signal; and
generating a first spatial component of a first weight for interference mitigation based on the covariance measure, the first spatial component and the second spatial component of the first channel coefficient and a scalar correction value.

27. The method of claim 26, comprising:
mitigating an interference at the first antenna port by applying the first spatial component of the first weight to the first signal.

28. The method of claim 26, comprising:
updating the covariance measure and the first spatial component of the first weight for interference mitigation on a chip-rate basis.

29. The method of claim 26,
wherein the covariance measure is a spatial covariance matrix of the first signal received at the first antenna port and the second signal received at the second antenna port.

30. The method of claim 26, comprising:
generating a second spatial component of the first weight for interference mitigation based on the covariance measure, the first and second spatial components of the first channel coefficient and the scalar correction value.

31. The method of claim 30, comprising:
mitigating an interference at the second antenna port by applying the second spatial component of the first weight to the second signal.

32. The method of claim 26,
wherein the scalar correction value is a multiplicative correction factor applied to one of the first channel coefficient and an inverse of the covariance measure.

33. The method of claim 26,
wherein the scalar correction value is based on a spreading factor of the at least one radio cell.

34. The method of claim 26,
wherein the scalar correction value is based on a cell load of the at least one radio cell.

35. The method of claim 34,
wherein the cell load of the at least one radio cell is generated based on a ratio of a total transmit power of the at least one radio cell and a transmit power of a common pilot channel of the at least one radio cell.

36. The method of claim 26,
wherein the scalar correction value is based on the term h₁^{H}R_{y}⁻¹h₁, wherein h₁ is a vector of the first channel coefficient, h₁^{H} is a vector of the Hermitian values of the first channel coefficient and R_{y}⁻¹ is an inverse matrix of the covariance measure which is formed as a matrix.

37. The method of claim 26, comprising:
generating the first weight for interference mitigation based on a multiplication of the scalar correction value with the term R_{y}⁻¹h₁, wherein h₁ is a vector of the first channel coefficient and R_{y}⁻¹ is an inverse matrix of the covariance measure which is formed as a matrix.

38. The method of claim 26, comprising:
generating the first weight for interference mitigation based on the relation:
$${w}_{1} = {SF ( 1 - {( \frac{{P}_{total}}{{P}_{CPICH}} )}_{c ( 1 )} {h}_{1}^{H} {R}_{y}^{- 1} {h}_{1} )}^{- 1} {R}_{y}^{- 1} {h}_{1} ,$$
wherein h₁ is a vector of the first channel coefficient, R_{y}⁻¹ is an inverse matrix of the covariance measure which is formed as a matrix, SF is a spreading factor of the radio cell c(1) related with the first antenna port and
$$( {( \frac{{P}_{total}}{{P}_{CPICH}} )}_{c ( 1 )} )$$
is the cell load of the radio cell c(1).

39. Interference mitigating receiver circuit, comprising:
a first antenna port configured to receive a first signal comprising multipath transmissions from at least one radio cell;
a second antenna port configured to receive a second signal comprising multipath transmissions from the at least one radio cell;
a first set of receiver taps coupled to the first antenna port and configured to generate first spatial components of a set of channel coefficients based on the first signal;
a second set of receiver taps coupled to the second antenna port and configured to generate second spatial components of the set of channel coefficients based on the second signal;
a covariance processing circuit configured to generate a covariance measure based on the first signal and the second signal; and
a weights processing circuit configured to generate first spatial components of a set of weights for interference mitigation based on the covariance measure, the first and second spatial components of the set of channel coefficients and a scalar correction value.

40. The interference mitigating receiver circuit of claim 39, comprising:
an interference cancellation circuit configured to cancel an interference at the first antenna port by applying the first spatial components of the set of weights to the first signal.

41. The interference mitigating receiver circuit of claim 40,
wherein the covariance processing circuit is configured to update the covariance measure and the first spatial components of the set of weights for interference mitigation on a chip-rate basis; and
wherein the interference cancellation circuit is configured to cancel the interference per chip-rate.

42. The interference mitigating receiver circuit of claim 39, comprising:
a circuitry that is configured to apply the scalar correction value as a multiplicative correction factor to one of the set of channel coefficients and an inverse of the covariance measure.

43. The interference mitigating receiver circuit of claim 39, comprising:
a circuitry that is configured to apply the scalar correction value based on a spreading factor of the at least one radio cell.

44. The interference mitigating receiver circuit of claim 39, comprising:
a circuitry that is configured to apply the scalar correction value based on a cell load of the at least one radio cell.

45. The interference mitigating receiver circuit of claim 39,
wherein the weights processing circuit is configured to generate second spatial components of the set of weights for interference mitigation based on the covariance measure, the first and second spatial components of the set of channel coefficients and the scalar correction value.

46. The interference mitigating receiver circuit of claim 45,
wherein the interference cancellation circuit is configured to cancel an interference at the second antenna port by applying the second spatial components of the set of weights to the second signal.

47. Interference mitigating receiver, comprising:
a plurality of antenna ports configured to receive a corresponding plurality of radio signals each radio signal comprising multipath transmissions;
a plurality of sets of receiver taps each set coupled to a respective one of the plurality of antenna ports configured to generate a respective spatial component of a set of channel coefficients based on the radio signal of the respective antenna port;
a covariance processor configured to generate a covariance measure based on the plurality of radio signals; and
a weights processor configured to generate for each antenna port a respective spatial component of a set of weights for interference mitigation based on the covariance measure, the spatial components of the set of channel coefficients and a scalar correction value.

48. The interference mitigating receiver of claim 47, comprising:
an interference cancellation circuit configured to cancel an interference at the plurality of antenna ports by applying the set of weights to the plurality of radio signals on a chip-rate basis.

49. The interference mitigating receiver of claim 47,
wherein each set of receiver taps comprises a set of Rake fingers.

50. The interference mitigating receiver of claim 47, comprising:
a circuitry that is configured to generate the scalar correction value as a multiplicative correction factor that depends on a spreading factor of at least one radio cell generating the plurality of radio signals and that depends on a cell load of the at least one radio cell.
